(19) United States
(12) Patent Application Publication
(10) Pub. No.: US 2018/0093304 A1
(43) Pub. Date: Apr. 5, 2018

(54) STEAM APPARATUS FOR CLEANING MICROWAVE OVENS

(71) Applicant: Sergio DeGennaro, Westbury, NY (US)

(72) Inventor: Sergio DeGennaro, Westbury, NY (US)

(21) Appl. No.: 15/285,644

(22) Filed: Oct. 5, 2016

(51) Int. Cl. B08B 3/00; B08B 9/08; B08B 9/087; B65D 43/02; B65D 47/06

(52) U.S. Cl. CPC B08B 3/00; B08B 9/0861; B65D 47/06; B65D 43/0225; B08B 9/087

(57) ABSTRACT

An apparatus for cleaning a microwave oven includes a vessel to form a steam chamber with an exhaust port. Water or other cleaning agent is placed in the bowl and the bowl is placed into the microwave oven and the oven is operated, steam is ejected from an orifice in a concentrated plume. The steam softens food remains and other dirt on the walls of the oven for easy removal.

### RELATED APPLICATIONS

None

### BACKGROUND OF THE INVENTION

### A. Field of the Invention

The present invention relates to cleaning a microwave oven using a steam cleaning apparatus. More particularly, it relates to an enclosed chamber having a bowl for boiling water and a funnel-shaped dome. The boiling water turns into steam which is released through the exhaust port in the funnel-shaped dome. The steam deposits on the walls of the oven and aids in cleaning the same.

### B. Description of the Prior Art

Cleaning a microwave is a burdensome chore that tends to take a lot more time than one wants to spend. This often leads to a microwave being left unkempt for long periods of time while spills and other messes build up along the sides, floor and roof of a microwave. More often than not, a person does not clean the microwave for a long period of time, resulting in the spilled substances or food scraps drying up and becoming more difficult to remove from the interior of the microwave.

Microwave users often look towards using cleaning agents to remove these unwanted substances and dry scraps from their microwave. However, these cleaning agents are not always effective and efficient in removing the mess left in the microwave. Moreover, some of the agents are caustic and may damage the interior surface of the oven, and/or its electronic circuitry.

Some users may place a cup or a flat saucer with water in the microwave (in the present description, the terms “microwave oven” and “microwave” are used interchangeably) and run it hoping allowing steam to fill up the microwave. However, typically such attempts do not result in sufficient steam to fill up the interior cooking area of the microwave.

While this cleaning technique has some benefits, there are several limitations as well. First, the cup or flat saucer will be extremely hot due to the transferring of heat from the boiling water in the cup. Further, a safety concern exists due to water being overheated. The movement of the cup of overheated water may cause rapid formation of bubbles. These bubbles rush to the surface and create a bursting effect that could result in a harmful injury to one's face or hands. Second, the cup is fully open to the interior of the microwave resulting in a longer time for the water to boil, but never creating any quality steam, because an uncovered cup or flat saucer will not allow any useable steam to be built up and create steam. Moreover, if insufficient amounts of water are used, or the cup or saucer are left in the microwave oven too long, all the water therein may evaporate leading to a potentially unsafe condition.

### SUMMARY OF THE INVENTION

In view of the deficiencies and drawbacks in other cleaning agents and/or techniques, an object of the present invention is to provide a closed vessel that will allow the microwave elements to boil the water and create a positive steam pressure in the oven.

A further object is to provide a vessel that can be easily removed from the oven even when hot and that is strong enough to withstand steam pressure and bubbles without bursting.

A further object of the present invention to provide a method of cleaning a microwave oven using a steam cleaning apparatus that has superior efficiency and would eliminate any risk of an injury to a user.

The steam cleaning apparatus consists of a base and a lid, where the lid is selectively attachable to the base. The base is constructed of a single piece of material, preferably a hard plastic such as polycarbonate. The base defines a water bowl with a laterally expanded rim for added safety. The water bowl has a floor, an inner wall and an outer wall.

The lid may also be constructed of a single piece of material, preferably a hard plastic such as polycarbonate. The lid includes an inner wall, outer wall, a dome having an exhaust port, wings, and a locking member. Preferably the exhaust port is configured so that it is always open through an orifice sizes and shaped to release a fine steam plume that expands evenly in all directions.

Preferably the base or lid are formed with a handle used to hold the vessel.

When the lid is removed, the water bowl is open at the top allowing a user to fill it with water.

### BRIEF DESCRIPTION OF THE DRAWINGS

FIG. 1 is a perspective view of the steam cleaning apparatus constructed in accordance with the present invention;

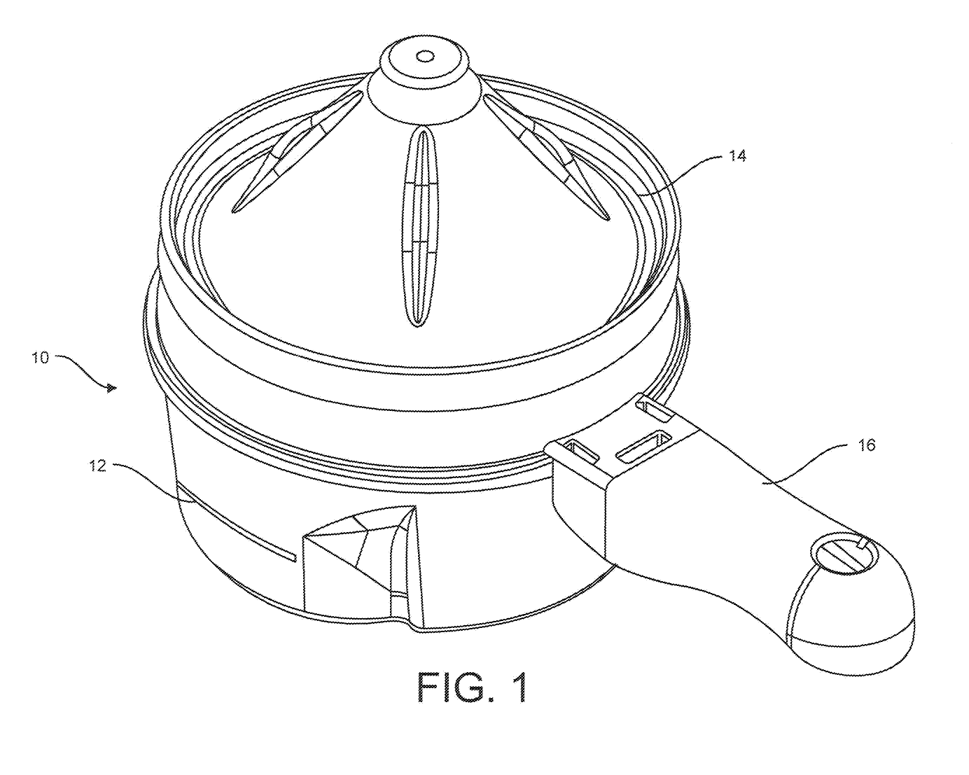

FIG. 2 is a perspective view of the bowl of the steam cleaning apparatus of FIG. 1;

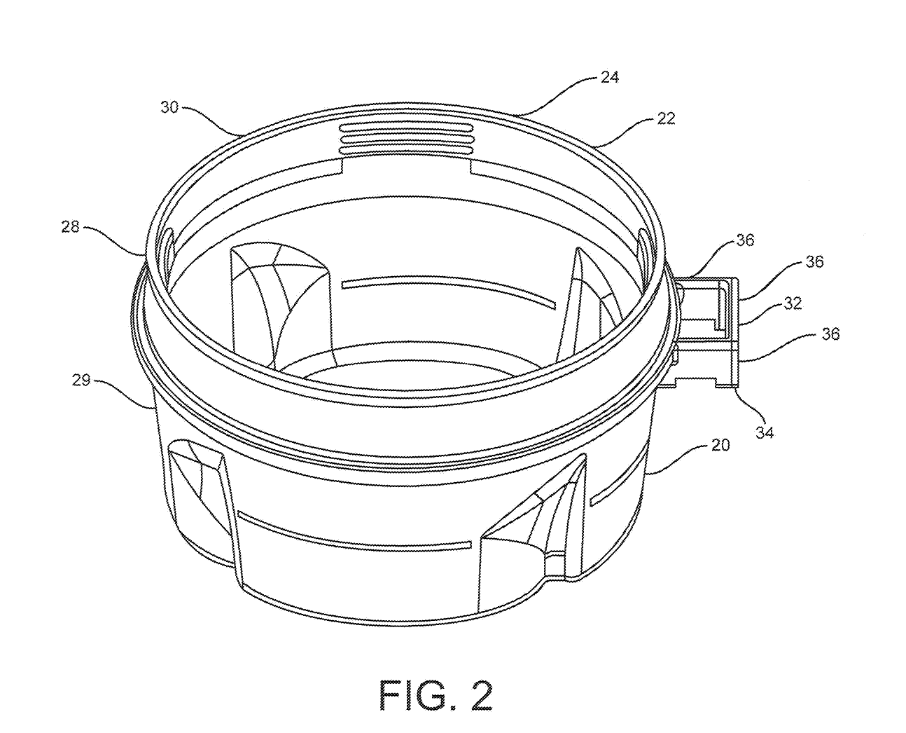

FIG. 3 is a perspective view of the lid of the steam cleaning apparatus of FIG. 1;

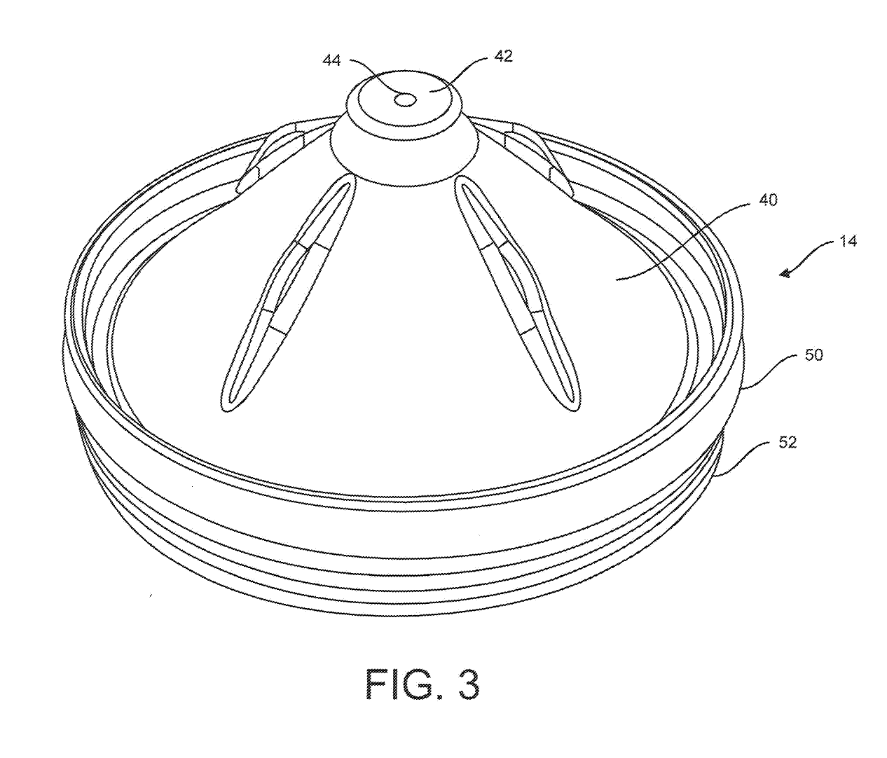

FIG. 4 shows a perspective of view of the handle of the steam cleaning apparatus of FIG. 1; and

FIG. 5 shows somewhat diagrammatically the steam cleaning apparatus of FIG. 1 placed into a microwave oven.

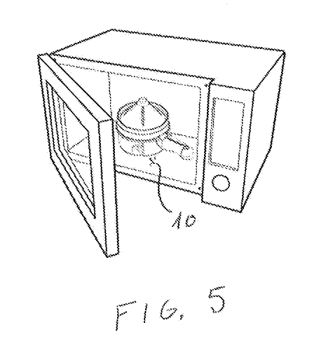

### DETAILED DESCRIPTION OF THE INVENTION

Referring now to the Figures, an apparatus or vessel 10 constructed in accordance with this invention includes a bottom portion forming a bowl 12 and a top portion forming a lid 14. The lid 14 is removably attached to the bowl 12 as described in more detail below. The apparatus or vessel 10 is also provided with a handle 16.

The bowl 12 is shown as being generally circular, however it may have other shapes as well. It includes an outer surface 20 and an inner surface 22 forming a space 24 for holding water. The bowl 12 is made of a transparent or translucent material, such as a plastic material that is microwaveable. The lid 14 can be made from the same material.

A line (not shown) is formed on the bowl to indicate a level to which the bowl should be filled with water or other similar cleaning liquid. A plurality of indentations 26 are formed in the sidewall of the bowl mainly for reinforcement. An upper portion of the inner surface 22 is provided with a plurality of horizontal partial grooves 28. In addition, outer surface 20 is formed with a circumferential rib 29 below the bowl lip 30. At the top, the bowl 12 is formed with a circumferential rib 29. A square or rectangular lug 32 is formed on the outer surface 20, below lip 29. The lug 32 is hollow from the top so that it can engage the removable handle 16 as discussed below. The lug 32 includes three vertical sidewalls 34, each terminating on their top surface with a tab 36.

The lid 14 includes a top conical surface 40 with a central flat boss 42 having an opening or orifice 44 communicating with the interior space 24 within the bowl 12. Several straight ribs 46 are provided that extend on the surface 40 to reinforce the lid 12. The lid 12 further includes a circumferential flat ring 50 disposed about surface 40. Extending downwardly from the ring 50 is a threaded ring portion 52. The lid 14 fits over the bowl 12 and rotating it causes the threaded ring portion 52 to engage the grooves 28 thereby selectively interlocking the bowl 12 and lid 14. The lid 14 can be rotated until is solidly tight on the bowl 12 and does not easily separate therefrom. In this manner, the lid 14 is prevented from accidentally separating from the bowl 12 and spilling its contents. Again, it should be emphasized that once the vessel 10 is closed, gases and steam formed therein are prevented from separating anywhere except through the orifice 44.

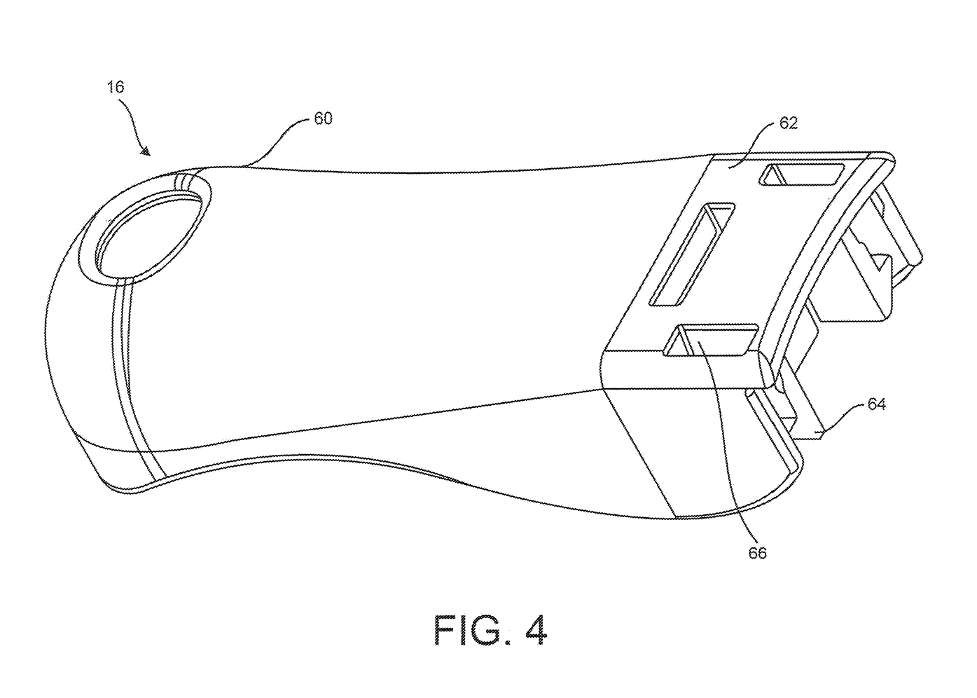

As shown in FIG. 4, handle 16 includes a body 60 sized to fit into a person's hands. At one end, body 60 is formed with a straight section 62 having downwardly extending internal walls 64 and a plurality of holes 66. The section 62 is sized and shaped so that it can be snapped over the lug 32 with walls 64 extending inside the lug 32 and the tabs 36 extending into halls 66. In this manner the vessel 10 can be carried by grasping holder 16.

Once interlocked, the lid 14 and the bowl 12 can be easily separated after the lid 14 is turned counterclockwise with respect to the bowl 12. Preferable the exhaust port 44 has a diameter of about ⅛- 1/16 in.

The apparatus is used as follows. The bowl 12 is filled with about 4-12 oz. of water (or other cleaning agent, made for example from water and some cleaning additive) and the lid 14 is then placed on the bowl 12 and twisted about a common vertical axis passing through the lid 14 and bowl 12 thereby causing the two portions to interlock.

The complete steam cleaning apparatus 10 thus formed is then placed inside a microwave oven (not shown) to begin the cleaning process of the microwave. The user programs the microwave oven to run on high for 1-8 minutes depending on the power generated by the specific microwave, its size, etc. While the microwave is operating, the water in the water bowl is heated to a boiling point, thereby generating steam within the bowl.

The steam is ejected through the orifice 44. The orifice 44 directs the steam out and away from apparatus 10 forming a concentrated plume of steam 62 to flow toward the walls of the oven and deposit thereon.

The steam then interacts with the scraps of dried food and any dirt that has been deposited on the oven walls and softens the same. Once the microwave finished operating, the apparatus 10 is removed from the oven and the walls of the oven are then cleaned using a soft cloth or other similar means.

It should be understood that the foregoing description is only illustrative of the invention. Various alternatives and modifications can be devised by those skilled in the art without departing from the invention. Accordingly, the present invention is intended to embrace all such alternatives, modifications and variances.

1-9. (canceled)

10. A method of cleaning a microwave oven comprising the steps of:
filing an apparatus with a cleaning agent wherein said apparatus includes an enclosure with an orifice configured to release a plume of steam; bowl;
placing said apparatus in a microwave oven; and
operating the microwave oven to cause the cleaning agent to generate steam, said steam being ejected by pressure within the apparatus into the microwave oven.

11. The method of claim 10 wherein said apparatus includes a bowl and a lid covering said bowl and defining a space for receiving said cleaning agent, wherein said step of filing includes separating said lid from said bowl, placing said cleaning agent into said bowl and closing said lid over said bowl.

12. A method of cleaning a microwave oven having one or more walls on which food and/or dirt has been deposited, the method comprising:
providing an apparatus having a base including a bowl and a lid selectively attachable to the base and which includes an upwardly directed orifice;
separating the lid from the base;
filling the bowl of the base with water to a desired level within the bowl;
attaching the lid to the base so that the bowl of the base is completely covered;
placing the apparatus inside the microwave oven;
operating the microwave oven for a period of time in order to heat the water in the bowl to a boiling point;
continue to operate the microwave oven in order to eject steam that is generated from the heated water through said orifice of said lid in a direction up and away from said apparatus;
interacting said ejected steam with said deposited dried food and/or dirt on said one or more microwave walls in order to soften said food and/or dirt;
turning the microwave off;
removing the apparatus from said microwave oven; and
wiping the walls of the microwave oven in order to remove the softened food and/or dirt.

13. The method of claim 12, further including adding a cleaning agent to said water prior to said filling step.

14. The method of claim 12, wherein said microwave is operational from between 1-8 minutes.

15. The method of claim 12, wherein the bowl of the base is filled with between 4 and 12 oz. of water.

16. The method of claim 12, wherein the lid is selectively attached to the base by placing the lid on the base and then causing the base and the lid to selectively interlock.
